(19) United States
(12) Patent Application Publication
(10) Pub. No.: US 2009/0226232 A1
(43) Pub. Date: Sep. 10, 2009

(54) SHEET-FED PRINTING PRESS

(75) Inventor: Jürgen Schölzig, Mainz (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: manroland AG, Offenbach (DE)

(21) Appl. No.: 12/097,853

(22) PCT Filed: Dec. 9, 2006
(86) PCT No.: PCT/EP06/11876

§ 371 Date: Oct. 8, 2008

(30) Foreign Application Priority Data
Dec. 17, 2005 (DE) 10 2005 060 441.2

(51) Int. Cl. B41J 11/44

(52) U.S. Cl. 400/76; 399/15

(57) ABSTRACT

The invention relates to a sheet-fed printing press, having at least one offset printing unit, varnishing unit and/or flexographic printing unit for printing printed sheets with at least one printing image. The printing press has at least one inspection device for detecting and evaluating each printing image which is printed onto the printed sheets in each offset printing unit, varnishing unit or flexographic printing unit. The printing press also includes at least one inkjet printing device and/or laser printing device which is integrated into the sheet-fed printing press for printing printed sheets with at least one further printing image. Each further printing image which is printed onto the printed sheets by each inkjet printing device and/or laser printing device also can be detected and evaluated by each inspection device.

### CROSS-REFERENCE TO RELATED APPLICATIONS

This patent application is the national phase of PCT International application No. PCT/EP2006/011876, filed Dec. 9, 2006, which claims the benefit of German Patent Application No. 102005060441.2, filed Dec. 17, 2005 which is incorporated by reference.

### FIELD OF THE INVENTION

The present invention relates generally to sheet-fed printing presses.

### BACKGROUND OF THE INVENTION

Sheet-fed printing presses are used to print on sheet-like substrates, which are also referred to as sheets. Known sheet-fed printing presses have at least one offset printing unit, at least one varnishing unit and/or at least one flexographic printing unit. Offset printing ink in the offset printing unit, a varnishing material in the varnishing unit, or a flexographic printing ink in the flexographic printing unit is selectively applied in the form of a print image onto the sheets. The print image printed onto the sheet in the offset printing unit and/or varnishing unit and/or flexographic printing unit is the same for all sheets to be printed. This is why one speaks of a static printing of the sheets in the offset printing unit, varnishing unit and/or flexographic printing unit.

To check the print quality of the print image printed in the offset printing unit, the varnishing unit and/or the flexographic printing unit, sheet-fed printing presses have at least one inspection device. With the inspection device, the static print image printed on the sheets in the offset printing unit, varnishing unit and/or flexographic printing unit can be detected and assessed. Such inspection devices are also referred to as sheet inspection systems and are known, for instance, from DE 202 13 431 U1.

Additionally, the integration of at least one inkjet printing device and/or at least one laser printing device into sheet-fed printing presses having an offset printing unit, varnishing unit and/or flexographic printing unit in order to print an additional print image on the sheet is known. Each inkjet printing device and/or laser printing device preferably serves to print a variable print image for each sheet in order to individualize the printed sheets. With the aid of the inkjet printing device and/or laser printing device, bar codes, numbers or other labels can be applied to the sheets to provide some individualization. The inkjet printing device and/or laser printing device can also serve for static printing of the sheets. The inkjet printing device and/or laser printing device can be based on nearly any functional principle, and can serve for the direct or indirect printing of the sheets. For example, an inkjet printing device can operate according to the continuous inkjet principle or the drop-on-demand inkjet principle and a laser printing device can operate according to the copy mark principle.

### OBJECTS AND SUMMARY OF THE INVENTION

A general object of the present invention is creating a novel sheet-fed printing press. According to the invention, any additional print image printed onto the sheet by an inkjet printing device and/or laser printing device can alternatively or additionally be detected and assessed by at least one inspection device.

According to prior art, this inspection device serves for detecting and assessing the print image applied in an offset printing unit, varnishing unit and/or flexographic printing unit.

Based on the detection and assessment, additional processes of the printing press could then be detected and controlled or regulated. Using the same inspection device to detect and assess print images applied by printing units or varnishing units and inkjet printing devices or laser printing devices assures a high degree of automation on sheet-fed printing presses while minimizing the necessary subassemblies.

According to one advantageous refinement of the invention, based on the inspection of the additional print image printed on the sheet by the inkjet printing device and/or laser printing device, the inspection device can initiate the marking or ejection of at least one faulty sheet having a defective page if there is a printing flaw in the additional print image printed on the sheet by the inkjet printing device and/or laser printing device. Faulty sheets can be marked by a stripe-insertion device. Faulty sheets can be ejected by a sheet deflector or a double discharge device. Alternatively or additionally, there can also be an alarm message.

Other objects and advantages of the invention will become apparent upon reading the following detailed description and upon reference to the drawings, in which:

### BRIEF DESCRIPTION OF THE SEVERAL VIEWS OF THE DRAWING(S)

FIG. 1 is a schematic side view of an exemplary sheet-fed rotary printing press according to the present invention.

### DESCRIPTION OF THE PREFERRED EMBODIMENTS

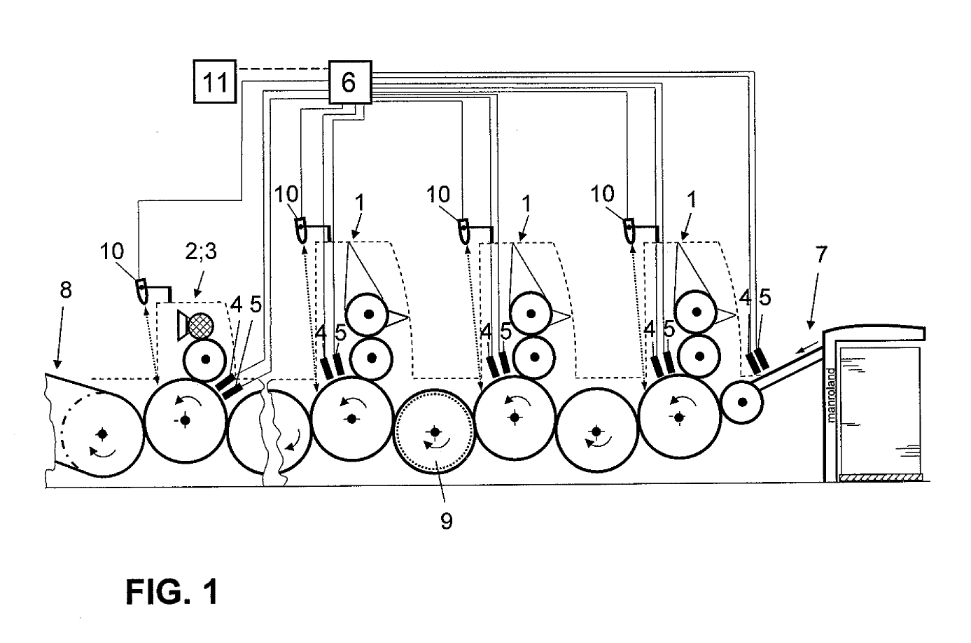

The present invention relates to sheet-fed rotary printing presses having at least one offset printing unit 1, at least one varnishing unit 2 and/or at least one flexographic printing unit 3 for printing at least one print image on sheets such as shown in FIG. 1. The offset printing unit 1, varnishing unit 2 and/or flexographic printing unit 3 serves to print at least one print image on the sheets that is identical for all sheets.

The sheet-fed printing press further comprises at least one inspection device 10 for detecting and assessing the print image printed onto the sheets in the offset printing unit 1, varnishing unit 2 and/or flexographic printing unit 3. Such inspection devices 10 are also referred to as sheet inspection systems.

The sheet-fed printing press according to the invention also has at least one inkjet printing device 4 and/or laser printing device 5 integrated into the sheet-fed printing press, for printing at least one additional print image on the sheets. The additional print image printed by the inkjet printing device 4 and/or laser printing device 5 onto the sheets is preferably a dynamic print image that is variable for all sheets. The print image printed onto the sheets by the inkjet printing device 4 and/or laser printing device 5 could also be a static print image that is identical for all sheets.

According to an aspect of the present invention, the inspection device 10 that detects and assesses the print image printed onto the sheets in the offset printing unit 1, varnishing unit 2 and/or flexographic printing unit 3 is alternatively or additionally used to detect and assess the additional print image printed onto the sheets by the inkjet printing device 4 and/or laser printing device 5. Based on this detection and assessment of the additional print image printed onto the sheets by the inkjet printing device 4 and/or laser printing device 5, it is possible to deduce the functional status of the inkjet printing device 4 and/or laser printing device 5.

Based on this detection and assessment of the additional print image printed onto the sheets by the inkjet printing device 4 and/or laser printing device 5, additional processes of the printing press can be controlled or regulated.

Thus, if a flaw or a misprint is recognized in the additional print image printed by the inkjet printing device 4 and/or laser printing device 5, marking or ejection of the defectively printed sheets, also referred to as bad sheets, can be initiated automatically. The defectively printed sheets can be marked with the aid of a so-called stripe-insertion device. The defectively printed sheets can be ejected via a sheet deflector, a double discharge device or an auxiliary stack. If a bad sheet is detected, an alarm message can also be generated. Then if the sheets contain several pages, each copy can be checked for a misprint in order to eject or mark bad sheets that have defective pages.

To assess the additional print image printed onto the sheet with the aid of the inkjet printing device 4 and/or laser printing device 5, the inspection device 10 is preferably coupled to a controller 6 of the sheet-fed printing press via at least one interface. The press controller 6 can store appropriate ideal print images with the aid of which the print images detected by the inspection device 10 can be compared. The inkjet printing device 4 and/or laser printing device 5 is then likewise coupled via at least one interface to the press controller 6.

Whenever the inkjet printing device 4 and/or laser printing device 5 serves to apply dynamic or variable print images to the sheets, a larger number of ideal print images must be stored in the press controller 6. This is not problematic, however, given the computational power available today.

Alternatively, it is also possible for the corresponding ideal print images to be stored not in the press controller 6, but in an external or separate evaluation unit 11, which exchanges data with the press controller 6 and the inkjet printing device 4 and/or laser printing device 5 via appropriate interfaces.

The above functionalities can also be coupled with operator console functions of the sheet-fed printing press, for instance, with a good sheet-counting function, a bad sheet-counting function, record-keeping functions or documentation functions. For this purpose, the press controller 6, the separate evaluation device 11 or the inspection device 10 is coupled to the operator console (which in the case of the illustrated embodiment is combined with the controller 6).

The invention can be used on a great many different configurations of sheet-fed printing presses. Thus it is possible, for example, for the sheet-fed printing press of the invention to be constructed as a conventional sheet-fed rotary printing press with a sheet feeder 7, with at least four offset printing units 1 serving for halftone combined printing, and a sheet delivery mechanism 8 such as shown in FIG. 1. With such an arrangement, at least one varnishing unit and/or flexographic printing unit 2, 3 can be arranged upstream and/or downstream of the offset printing units 1. The inkjet printing device 4 and/or laser printing device 5 can be arranged in the area of the sheet feeder 7. Alternatively, the inkjet printing device 4 and/or laser printing device 5 can also be integrated into an offset printing unit 1, varnishing unit 2 or flexographic printing unit 3. The presence, number and order of the offset printing units 1, varnishing units 2 and/or flexographic printing units 3 in the sheet-fed printing press of the invention is arbitrary. The presence, number and position of the inkjet printing devices 4 and/or laser printing devices 5 integrated into the sheet-fed printing press is likewise arbitrary.

It is also possible to use the invention with sheet-fed printing presses that serve for double-sided printing of sheets. In this case, at least two inspection devices are then integrated into the printing press, namely, one inspection device for detecting and assessing a first form side and one for detecting and assessing a second form side of the sheets.

The sheet-fed printing press of the invention can alternatively be constructed as a pure finishing machine that comprises no offset printing units.

1-10. (canceled)

11. A sheet-fed printing press comprising:
at least one first printing unit from the group consisting of an offset printing unit, a varnishing unit and flexographic printing unit for printing at least one print image on sheets;
an inspection device for detecting and assessing the at least one print image printed on the sheets; and
at least one second printing device from the group consisting of an inkjet printing device and a laser printing device for printing at least one additional print image on sheets, wherein the inspection device and the second printing device are arranged such that the additional print image can be detected and assessed by the inspection device.

12 The sheet-fed printing press according to claim 11, wherein, a functional status of the second printing device is determinable based on the detection and assessment of the additional print image by the inspection device.

13. The sheet-fed printing press according to claim 11, wherein the inspection device initiates a determination of a faulty sheet when the detection and assessment of the additional print image printed onto the sheets recognizes a misprint is recognized in the additional print image.

14. The sheet-fed printing press according to claim 13, wherein a plurality of sheets comprise a printed article and the inspection device initiates a determination that the printed article is faulty when the detection an assessment of the additional print image printed onto a sheet of the printed article recognizes a misprint in the additional print image on at least one of the sheets of the printed article.

15. The sheet-fed printing press according to claim 11, wherein the first printing unit prints at least one static print image that is identical for all sheets.

16. The sheet-fed printing press according claim 11, wherein the second printing device prints at least one dynamic print image that is variable for all sheets.

17. The sheet-fed printing press according to claim 11, wherein the second printing device prints at least one static print image that is identical for all sheets.

18. The sheet-fed printing press according to claim 11, wherein the second printing device is integrated into the printing press upstream of the first printing unit in a transport direction of the sheets.

19. The sheet-fed printing press according to claim 11, wherein the second printing device is integrated into the printing press downstream of the first printing unit in a transport direction of the sheets.

20. The sheet-fed printing press according to claim 11, wherein the inspection device and the second printing device are coupled to a press controller that stores a plurality of ideal print images via interfaces, the controller being configured to compare at least one of the ideal print images with the additional print image detected by the inspection device.

21. The sheet-fed printing press according to claim 11, wherein the inspection device and the second printing device are coupled to a separate evaluation device that stores a plurality of ideal print images via interfaces.

22. The sheet-fed printing press according to claim 20, wherein the press controller is coupled to an operator console.

23. The sheet-fed printing press according to claim 21, wherein the separate evaluation unit is coupled to an operator console.

24. The sheet-fed printing press according to claim 20, wherein the second printing device is coupled to an operator console.
